(19) United States
(12) Patent Application Publication
(10) Pub. No.: US 2014/0132781 A1
(43) Pub. Date: May 15, 2014

(54) MOBILE DEVICE CAMERA ACCESSORY

(71) Applicants: William Adams, Beverly Hills, CA (US); Chandrasekar Rathakrishnan, Singapore (SG)

(72) Inventors: William Adams, Beverly Hills, CA (US); Chandrasekar Rathakrishnan, Singapore (SG)

(73) Assignee: I.AM.SYMBOLIC, LLC, Beverly Hills, CA (US)

(21) Appl. No.: 14/074,581

(22) Filed: Nov. 7, 2013

Related U.S. Application Data
(60) Provisional application No. 61/724,664, filed on Nov. 9, 2012.

(51) Int. Cl. G06F 3/00; H04N 5/232; H04N 5/225

(52) U.S. Cl. CPC G06F 3/005; H04N 5/2254; H04N 5/23296
USPC 348/207.1

(57) ABSTRACT

Embodiments include a mobile device camera accessory. The mobile device camera accessory includes a digital imaging sensor and a camera lens mount that is configured to optically align a camera lens with the digital imaging sensor. The accessory also includes a communications interface that is configured to communicate with a mobile computing device. An accessory system includes an accessory base that comprises a digital imaging sensor, a camera lens mount, and a mobile computing device mount. The accessory base also includes a communications interface that is configured to communicate with a mobile computing device. The accessory system further includes a camera lens that is configured to attach to the camera lens mount and to optically align over the digital imaging sensor when attached to the camera lens mount.

### CROSS-REFERENCE TO RELATED APPLICATIONS

This application claims priority to and the benefit of U.S. Provisional Application Ser. No. 61/724,664, entitled “Mobile Device Camera Accessory”, filed on Nov. 9, 2012, which application is incorporated by reference in its entirety herein.

### BACKGROUND

The recent proliferation of mobile computing devices, such as smartphones, digital media players, and tablet computers has been astounding. Mobile computing devices have become an integral part of modern life, and are now possessed by a significant portion of the population. As mobile computing devices have evolved, they have become capable of performing significant computing tasks, such as image and video processing/editing, the capture of digital images and movies, and the communication of digital images and movies to other electronic devices. As the computing and imaging abilities of mobile computing devices have evolved, they have been able to replace much of the functionality of consumer-grade digital point-and-shoot cameras for a large number of people.

### BRIEF SUMMARY

Embodiments described herein extend to mobile device camera accessories that greatly enhance the image capture abilities of mobile devices by providing an external image sensor that enables the capture of professional-level digital images and/or movies. Mobile device camera accessories according to embodiments described herein can also enable use of a variety of different lenses, and can enable image capture either using a hard-wired connection or a wireless connection with a mobile computing device.

In some embodiments, a mobile device camera accessory includes a digital imaging sensor and a camera lens mount that is configured to optically align an interchangeable camera lens with the digital imaging sensor, where the camera lens mount houses the digital imaging sensor. The mobile device camera accessory also includes a communications interface that provides communication with a mobile computing device. The communications interface allows users of the mobile device camera accessory to control mobile device camera accessory operations using a user interface displayed on the mobile computing device.

In other embodiments, a mobile device camera accessory system includes an accessory base that comprises a digital imaging sensor, a camera lens mount, and a mobile computing device mount. The accessory base also comprises a communications interface that is configured to communicate with a mobile computing device. The mobile device camera accessory system also includes a camera lens that is configured to attach to the camera lens mount and to optically align over the digital imaging sensor when attached to the camera lens mount.

Yet other embodiments extend to a method, from the perspective of a camera accessory, for capturing a digital image. The method includes the camera accessory establishing communications channels with a mobile communications device. The camera accessory communicates the identity and/or current state of an attached lens to the mobile communications device, and the camera accessory receives instructions from the mobile communications device over the communications channels. The instructions instruct the camera accessory to capture a digital image at a digital imaging sensor at the camera accessory. The camera accessory transfers the captured digital image to the mobile communications device over the communications channels.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a front perspective view of a mobile device camera accessory, according to one or more embodiments of the present invention.

FIG. 2 illustrates a front perspective view of a mobile device camera accessory that is attached to a mobile computing device, according to one or more embodiments of the present invention.

FIG. 3 illustrates a rear perspective view of a mobile device camera accessory that is attached to a mobile computing device, according to one or more embodiments of the present invention.

FIG. 4 illustrates a side perspective view of a mobile device camera accessory, according to one or more embodiments of the present invention, which depicts a mobile device attachment mechanism.

FIG. 5 illustrates a side perspective view of a mobile device camera accessory, according to one or more embodiments of the present invention, which depicts a mobile computing device being inserted into a mobile device attachment mechanism.

FIG. 6 illustrates a mobile device camera accessory being coupled wirelessly with a mobile computing device, according to one or more embodiments of the present invention.

FIG. 7 illustrates a front perspective view of a mobile device camera accessory, according to one or more embodiments of the present invention, which details a zoom camera lens.

FIG. 8 illustrates a front perspective view of a mobile device camera accessory, according to one or more embodiments of the present invention, which details a removable camera lens.

FIG. 9 illustrates a front perspective view of a mobile device camera accessory, according to one or more embodiments of the present invention, which details a digital imaging sensor.

FIG. 10 illustrates a front perspective view of a mobile device camera accessory, according to one or more embodiments of the present invention, which details a third-party camera lens.

FIG. 11 illustrates a perspective view of a lens cover of a mobile device camera accessory being used as a grip, according to one or more embodiments of the present invention.

FIG. 12 illustrates a flowchart of a method, from the perspective of a mobile device camera accessory, for capturing a digital image, according to one or more embodiments of the present invention.

### DETAILED DESCRIPTION

Embodiments described herein extend to mobile device camera accessories that greatly enhance the image capture abilities of mobile devices by providing an external image sensor that enables the capture of professional-level digital images and/or movies. Mobile device camera accessories according to embodiments described herein can also enable use of a variety of different lenses, and can enable image capture either using a hard-wired connection or a wireless connection with a mobile computing device.

Mobile computing devices according to embodiments described herein can include multi-purpose mobile computing devices, such as smartphones, feature phones, digital media players, tablet computers, laptops or other types of mobile computing systems. As used herein, multi-purpose mobile computing devices include the ability to be repurposed for various functions. For example, multi-purpose mobile computing devices may include (and/or provide the ability to have installed thereon) a plurality of applications (apps) that, when executed, repurpose the multi-purpose mobile computing device for different functions. As such, mobile computing devices can comprise general computing devices that can be re-purposed for different particular functionality through the use of different apps. In some embodiments, mobile computing devices comprise mobile communications devices that are also multi-purpose mobile computing devices.

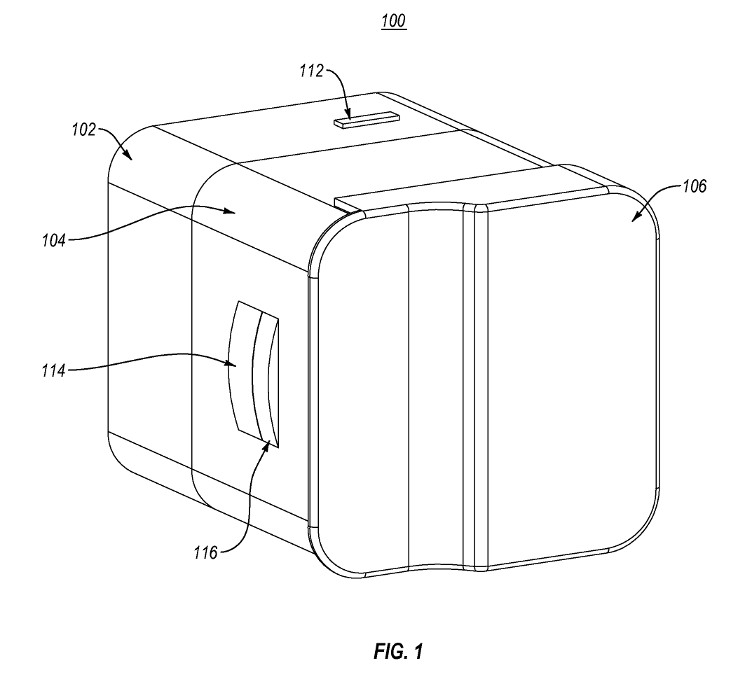

FIG. 1 illustrates a front perspective view of a mobile device camera accessory 100, according to one or more embodiments. As depicted, camera accessory 100 includes an accessory base 102, a lens 104, and a lens cap 106. FIG. 1 also illustrates that accessory base 102 can also include a shutter button 112, and that lens 104 can include lens control mechanisms, such as a zoom adjustment mechanism 114 and a focus adjustment mechanism 116. Although not depicted in FIG. 1, accessory base 102 includes a digital imaging sensor (e.g., charge-coupled device (CCD), complementary metal-oxide-semiconductor (CMOS), or other types of sensors), a camera lens mount for attaching lens 104 to accessory base 102, and one or more communications interfaces that are configured to communicate with a mobile computing device.

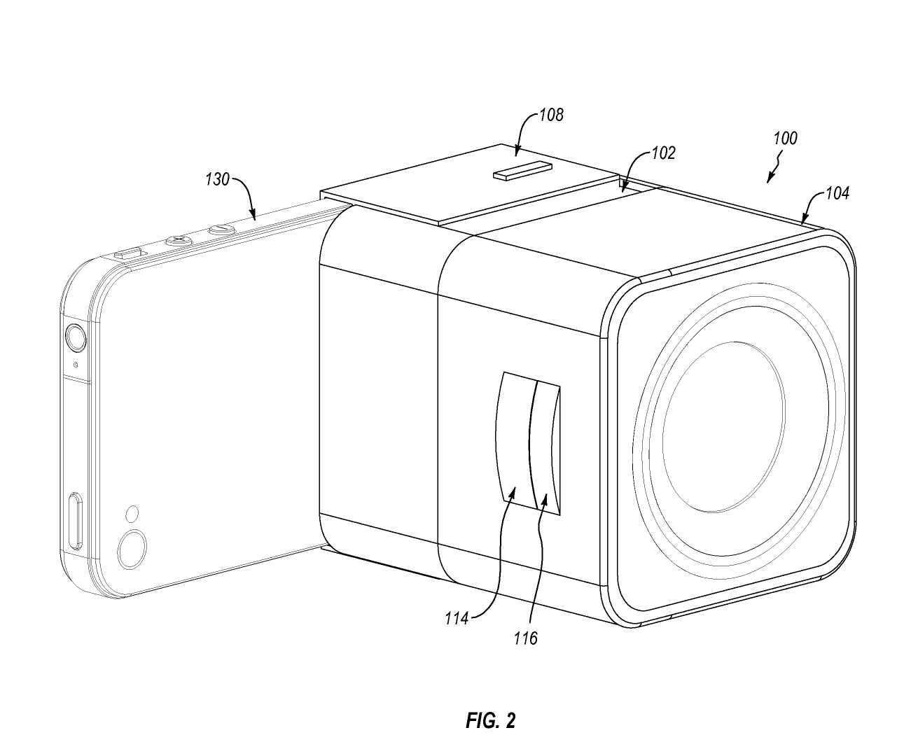

Accessory base 102 can also include one or more attachment mechanisms for connecting accessory base 102 to a mobile computing device. The accessory base may be designed for one particular type or brand of phone, or may be designed in a more generic manner to fit onto a variety of different phone types or brands. FIG. 2 illustrates a front perspective view of the mobile device camera accessory 100, as attached to a mobile computing device 130. The mobile device camera accessory 100 (or simply “camera accessory” herein) may be mounted or attached to substantially any portion of the mobile device 130. As shown in FIG. 2, the camera accessory 100 is mounted to the lower portion of the mobile device 130, but it could be mounted or attached elsewhere. The camera accessory 100 may be clipped or otherwise mounted or attached using brackets 108. These brackets hold the camera accessory 100 securely in place wherever it is mounted on the mobile device.

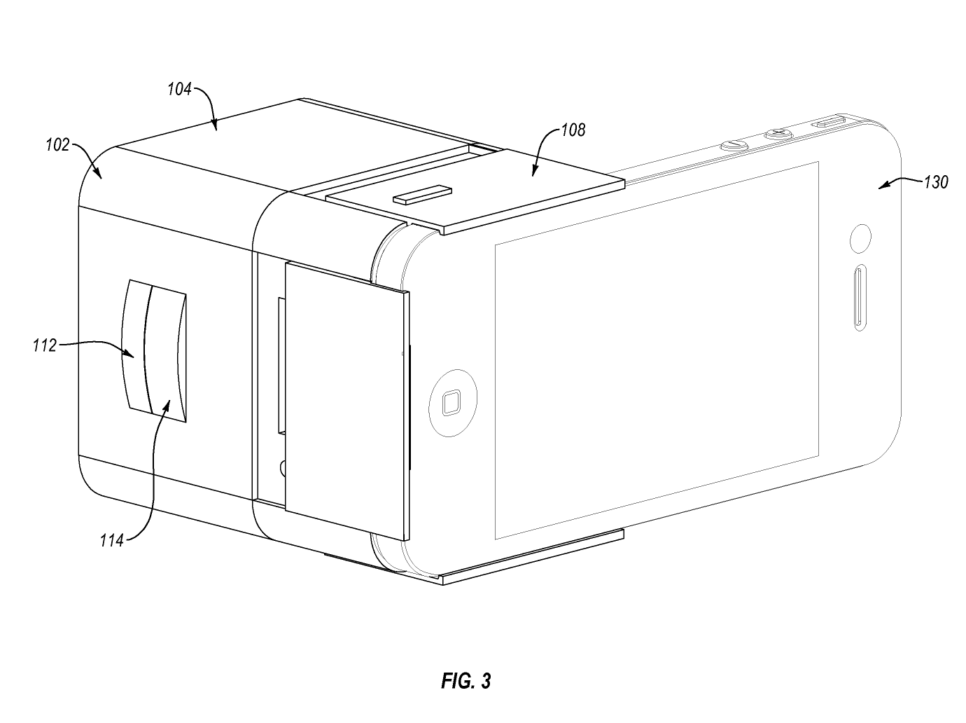

FIG. 3 illustrates a rear perspective view of mobile device camera accessory 100, as attached to the mobile computing device 130. As is illustrated on the mobile computing device 130, recently taken pictures may be shown to the device user. These pictures may be shown after an image is taken using the camera accessory 100, or upon request by the user. The mobile device 130 may further be configured to show a user interface that allows interaction with and/or controls the camera accessory 100. For instance, the mobile device 130 may display a button for taking a picture or video using the camera accessory 100. Additionally or alternatively, the user interface may include controls for operating the lens 104 including focus or zooming features, controls for taking multiple pictures or certain types of pictures (e.g. panorama pictures), or other controls that can be used to operate features of the camera accessory 100. It should also be understood that while the mobile device 130 is shown facing outward relative to the camera accessory 100, the mobile phone may also be placed facing inward relative to the camera accessory. For instance, a user may wish to take pictures or video of themselves and view the shot on the mobile device's screen before taking it, or while filming the video.

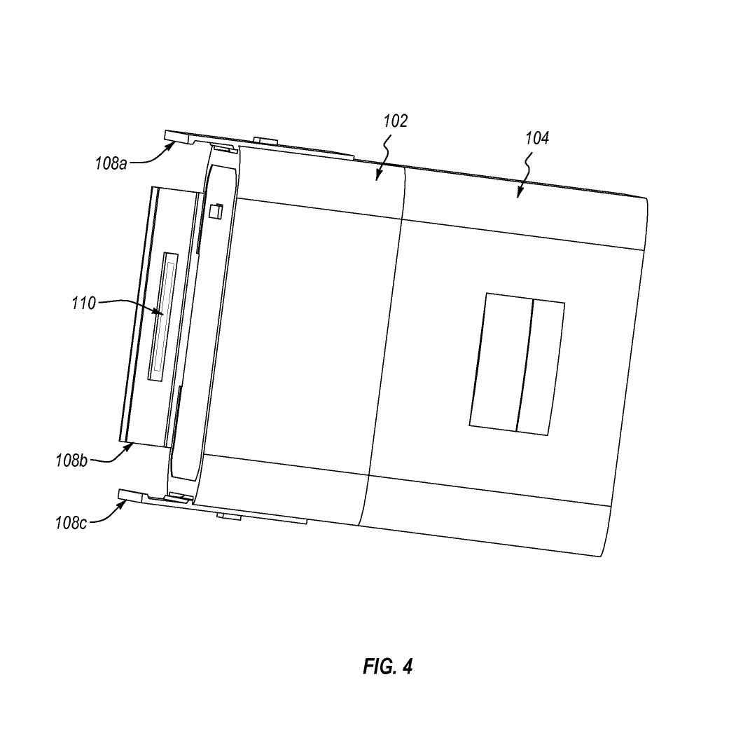

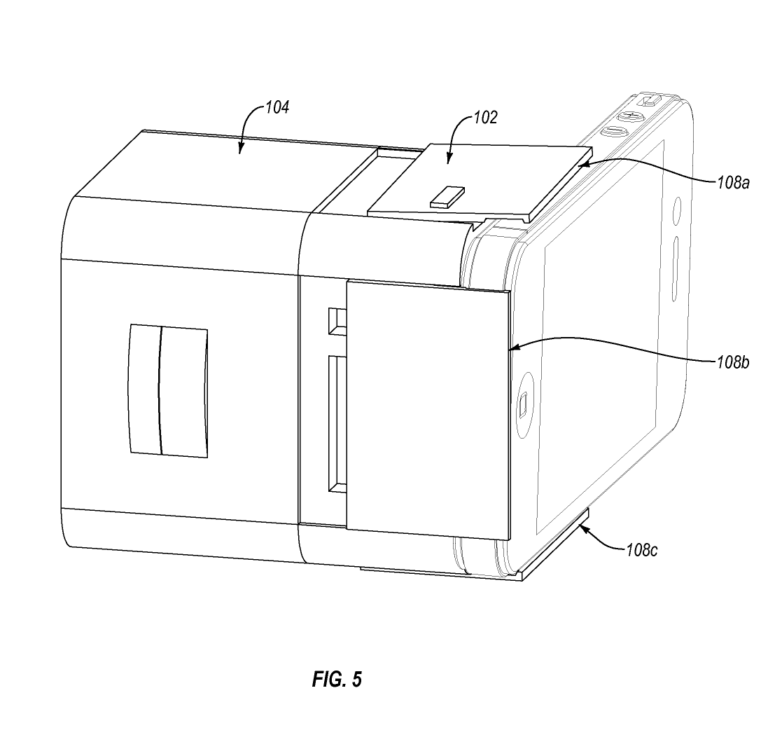

FIGS. 4 and 5 illustrate one embodiment of an attachment mechanism for connecting accessory base 102 to a mobile computing device in more detail. As depicted, an attachment mechanism can include a plurality of brackets 108 (108a, 108b, 108c). Brackets 108 may be configured to attach to a mobile computing device, for example, by clipping onto the edges of the mobile device. At least in some cases, these brackets may slide and/or retract into or onto the accessory base 102 when not in use. Brackets 108 may be configured to provide an adjustable width to accommodate mobile computing devices of varying size. Brackets 108 may include one or more springs which enable brackets 108 to expand during insertion of a mobile computing device and to securely fasten itself to the mobile computing device, once inserted (see FIG. 5).

An attachment mechanism can include any appropriate connector or connectors for interfacing with a mobile computing device (e.g. 130), and for securing a mobile computing device to accessory base 102. For example, FIG. 4 illustrates that accessory base 102 includes connector 110. Connector 110 can comprise any appropriate means of physical and/or electrical connection, such as one or more of UNIVERSAL SERIAL BUS, APPLE DOCK CONNECTOR, or APPLE LIGHTNING. Correspondingly, the communications interface 110 is configured to communicate with the mobile computing device 130, and can include a hard-wired communications interface (e.g., UNIVERSAL SERIAL BUS, APPLE DOCK CONNECTOR, or APPLE LIGHTNING). In some embodiments, connector 110 is configured to bi-directionally attached to a mobile computing device, such that the mobile computing device can be inserted in a plurality of orientations (e.g., with a screen away from mobile device camera accessory 100 in a “rear facing” configuration, or with the screen toward mobile device camera accessory 100 in a “front facing” configuration).

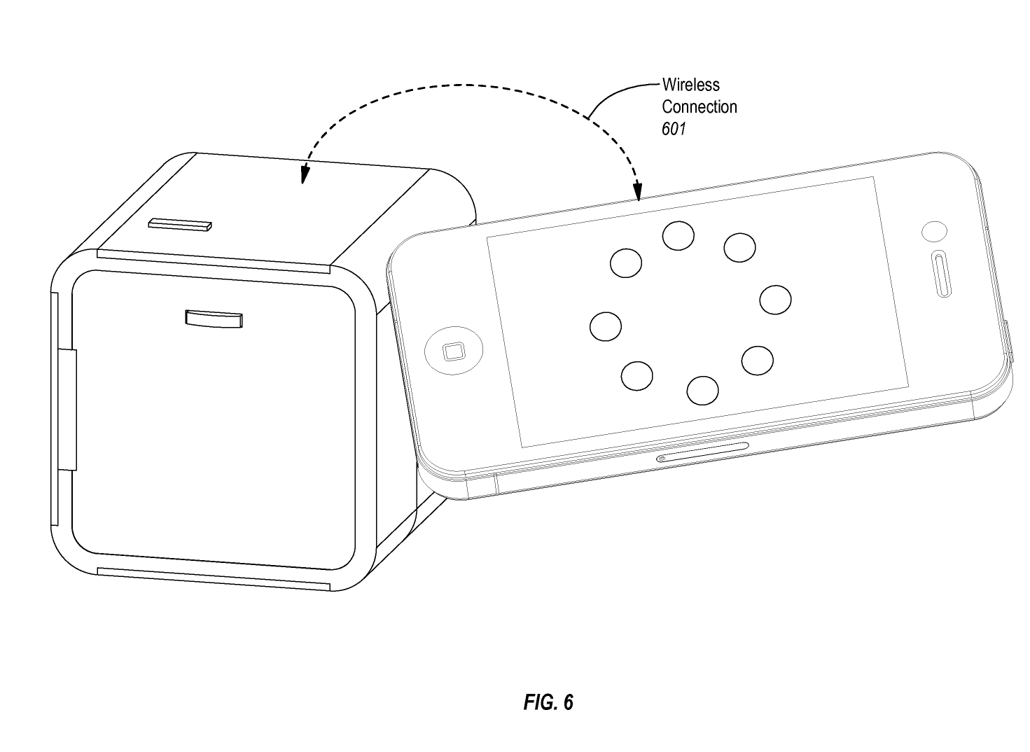

In some embodiments, the connector 110 includes a wireless communications interface. For example, the communications interfaces may include WIFI, BLUETOOTH, NEAR FIELD COMMUNICATIONS, or any other appropriate wireless communications technology. FIG. 6 illustrates that when a wireless communications interface is used, a mobile computing device may communicate with mobile device camera accessory 100 wirelessly (e.g. using wireless connection 601). As such, mobile device camera accessory 100 may receive instructions from a mobile computing device over a wireless communications interface, and may transfer images and/or video over to the mobile computing device 130 over the wireless communications interface. Mobile device camera accessory 100 can therefore function as a remote camera for one or more mobile computing devices including mobile computing device 130. As such, a user may control various aspects or features of the camera accessory 100 using the wired or wireless communications interface. As will be understood by one skilled in the art, the wired connection may be accomplished using the connector 110, and a wireless connection may be accomplished using any of a plurality of different built-in (internal) or external radios.

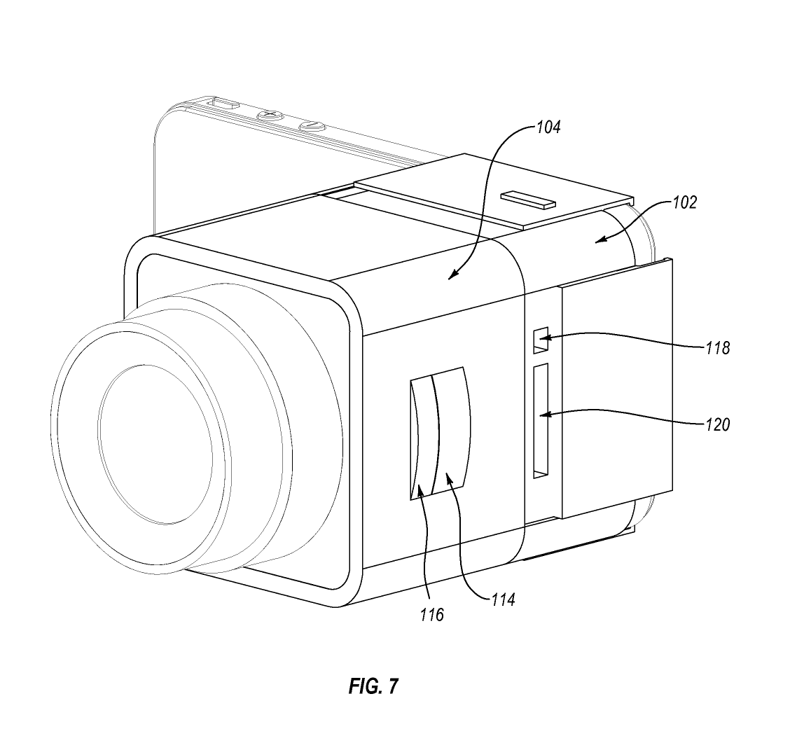

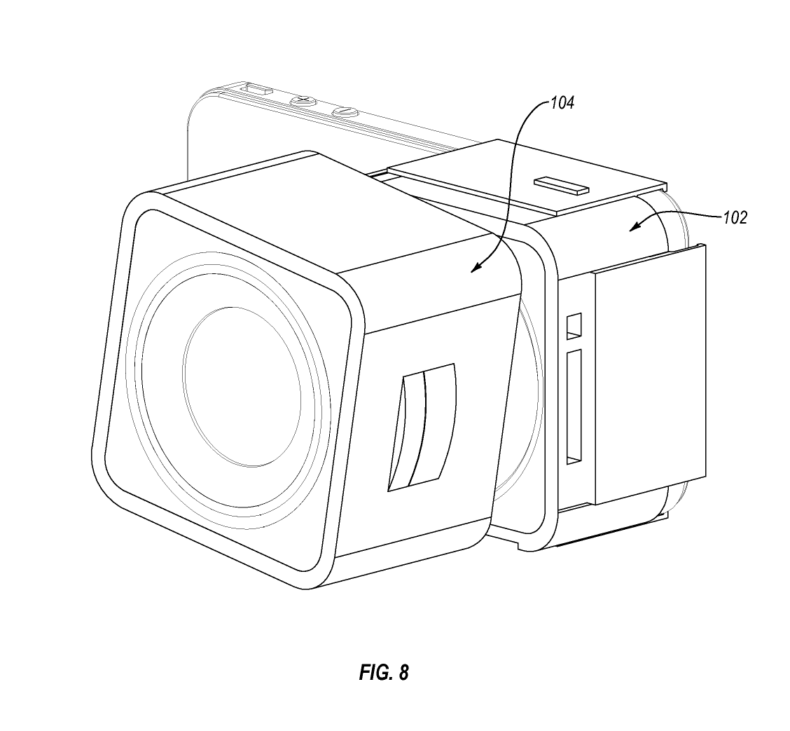

Turning to FIG. 7, an accessory base 102 is illustrated with additional connectors, such as microphone/headphone jack 118 and mobile computing device connector 120. Connector 120 may pass-through to connector 110 (FIG. 4), for example. Connector 120 may be usable to charge or otherwise provide power to the mobile computing device 130 that is attached to accessory base 102. As depicted, when brackets 108 are retracted, the brackets may cover one or more of the additional connectors. FIG. 7 also depicts lens 104, with zoom adjustment mechanism 114 and focus adjustment mechanism 116, in greater detail. In FIG. 7, lens 104 is in a zoomed configuration. As will be understood, various different types of lenses may be used within the lens housing, including zoom lenses and fixed lenses. FIG. 8 depicts that lens 104 is configured to be removed from accessory base 102 by twisting the attaching lens 104 relative to accessory base 102. In some embodiments, one or both of attaching lens 104 or accessory base 102 may include a lens release mechanism (e.g., button, switch, etc.) that allows the lens to separate from the accessory base 102.

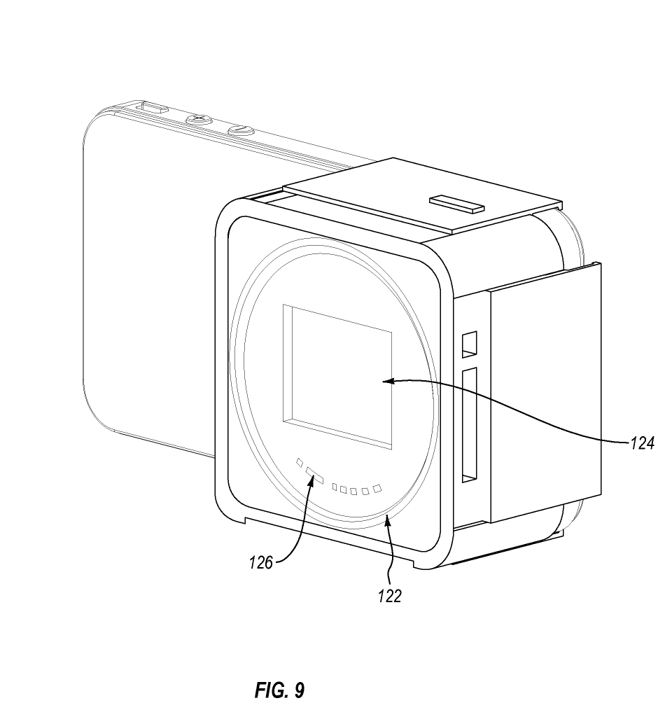

FIG. 9 illustrates accessory base 102 with attaching lens 104 removed. FIG. 9 depicts that accessory base 102 includes a camera lens mount 122 and a digital imaging sensor 124. As mentioned above, the digital imaging sensor may be a CCD, a CMOS sensor or other type of image sensor. FIG. 9 also depicts that accessory base 102 and/or camera lens mount 122 includes one or more electrical connectors 126 for connecting to and communicating with an attached camera lens 104. Using electrical connectors 126, accessory base 102 can be enabled for uni-directional or bi-directional communication with the attached camera lens 104. For example, electrical connectors 126 can be used to receive lens identifier information and lens state information (e.g., aperture, zoom level, focus data) from attached lens 104, and/or to send lens instructions (e.g., desired zoom level, aperture, etc.) to attached lens 104. Accessory base 102 can send lens-related data to a mobile computing device over hard-wired and/or wireless communications channels, and can receive lens-related data/instructions from the mobile computing device 130 over the same or different hard-wired and/or wireless communications channels.

Camera lens mount 122 and/or electrical connectors 126 can be configured to enable lenses of different types to be attached to accessory base 102. For example, camera lens mount 122 and/or electrical connectors 126 may be configured to accommodate lenses produced from a variety of third-parties (e.g., CANON, NIKON, OLYMPUS, MINOLTA, etc.). In particular, camera lens mount 122 and/or electrical connectors 126 may be configured to accommodate professional-quality single-lens reflex (SLR) type lenses from a variety of third-party manufacturers. In some embodiments, camera lens mount 122 and/or electrical connectors 126 may be configured to be used in connection with one or more lens adapters that enable a variety of different lenses to interface with camera lens mount 122 and/or electrical connectors 126. Accessory base 102 may be configured to communicate with lenses having a variety of communications protocols.

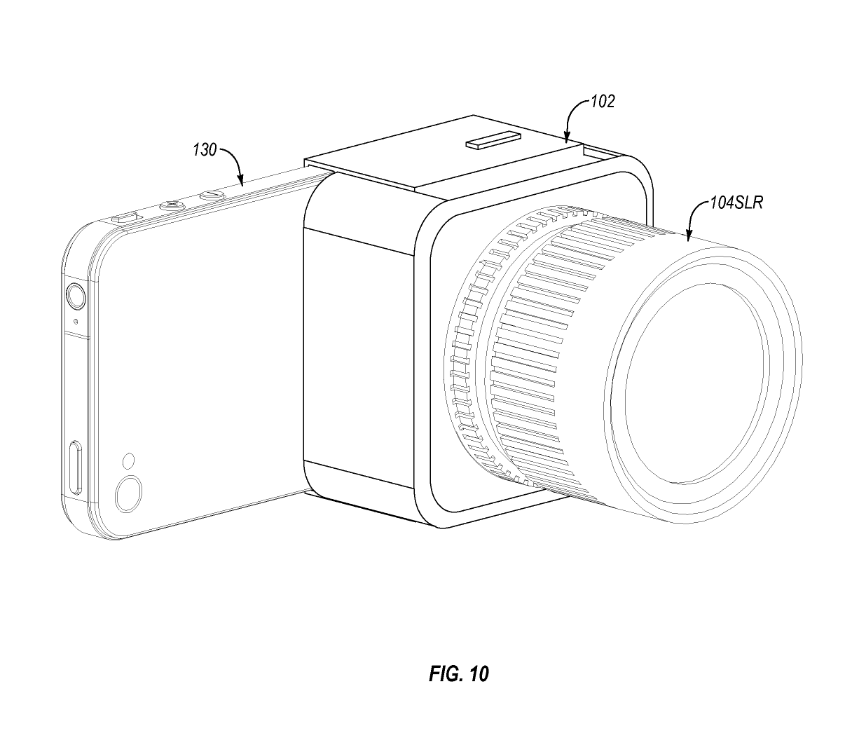

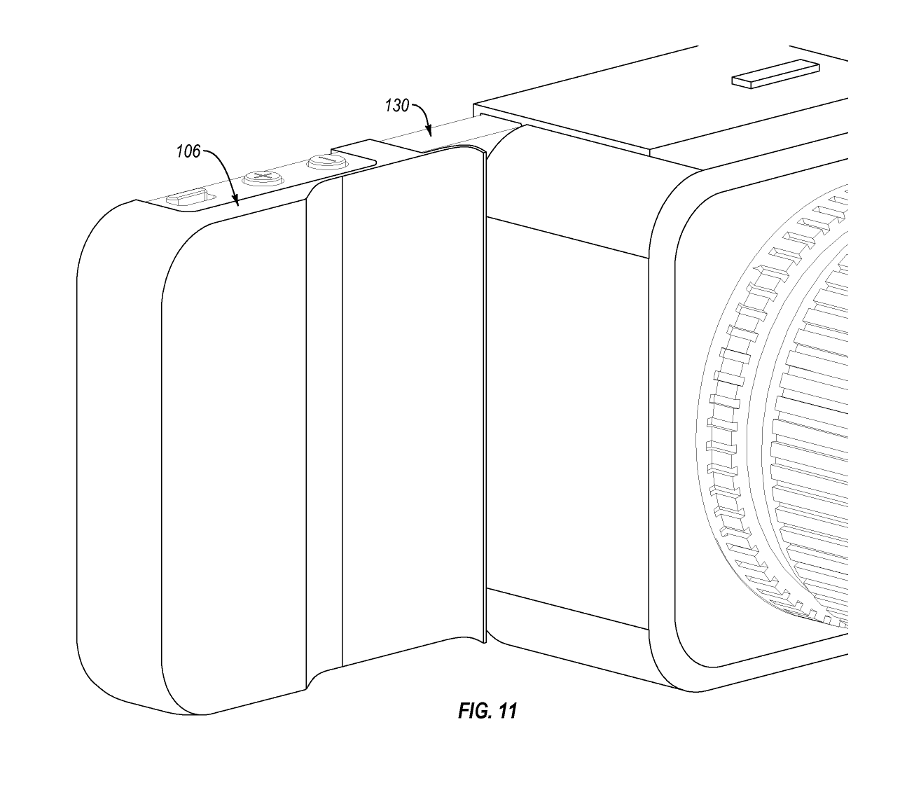

When combined with a high-quality imaging sensor 124, accessory base 102 can enable professional quality image capture using mobile computing devices. For example, FIG. 10 depicts accessory base 102 being used in connection with a SLR-type lens 104SLR that may typically be used in connection with a professional-quality SLR camera. FIG. 11 depicts that lens cap 106 can be configured to be attached (e.g., snap-on, slide-on, etc.) to the mobile computing device 130, and to serve as a grip when attached to the mobile computing device 130.

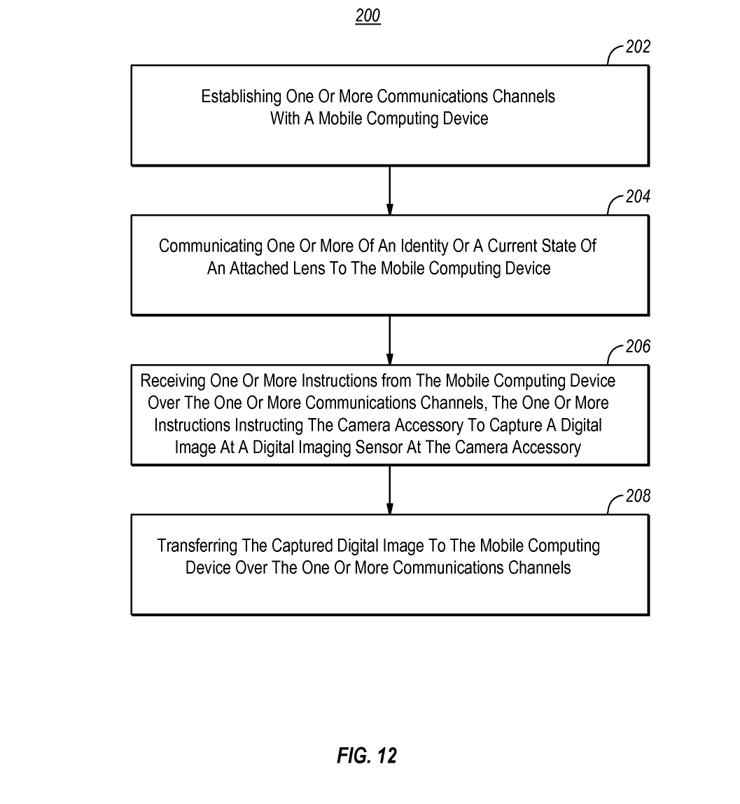

FIG. 12 illustrates a flow chart of an example method 200 for capturing a digital image. Method 200 will be described with respect to the mobile device camera accessory 100 depicted in FIGS. 1-11.

Method 200 comprises an act of establishing one or more communications channels with a mobile computing device (act 202). For example, accessory base 102 can establish one or more communications channels with mobile computing device 130. The mobile computing device may be a feature phone, a smartphone, a tablet, a laptop or other type of mobile computing device. The communications channels may comprise one or both of hard-wired or wireless communications channels. The communications channels can be usable for transferring data and/or instructions from the mobile computing device 130 to the accessory base 102, and/or for transferring data and/or instructions from the accessory base 102 to the mobile computing device.

Method 200 also comprises an act of communicating one or more of an identity or a current state of an attached lens to the mobile computing device (act 204). For example, accessory base 102 can receive the identity or a current state of an attached lens via electrical connectors 126 and communicate this information to the mobile computing device 130 over the one or more communications channels. The lens identity may indicate which type of lens it is, including brand name and/or technical specifications. The lens identity may indicate which features are to be shown in a user interface presented in the mobile computing device. For instance, some lenses may have features not provided by other lenses. As such, in those cases, the user interface may provide controls for the unique features provided by each lens. Still further, the current state information may indicate to the mobile computing device that the imaging sensor is in an operational state, or is in an error state, or is turned off

Method 200 also comprises an act of receiving one or more instructions from the mobile computing device over the one or more communications channels, the one or more instructions instructing the camera accessory to capture a digital image at a digital imaging sensor at the camera accessory (act 206). For example, accessory base 102 can receive one or more instructions from the mobile computing device 130 to acquire an image using digital imaging sensor 124. The instructions may be responsive to user input received at a user interface provided by software of the mobile computing device, to user input provided using a physical button of the mobile computing device 130, or to user input provided at an input mechanism on camera accessory 100, such as shutter button 112.

Method 200 further comprises an act of transferring the captured digital image to the mobile computing device over the one or more communications channels (act 208). For example, after capturing one or more digital images using digital imaging sensor 124, accessory base 102 can transfer at least one of the images to the mobile computing device 130 over the one or more communications channels (e.g. via wired connector 110 or via wireless connection 601). It will be appreciated that camera accessory 100 and the mobile computing device 130 can transfer a variety of data/instructions. For example, camera accessory 100 may receive one or more instructions from the mobile computing device, which instruct the camera accessory to adjust one or more of aperture, zoom, or focus of an attached lens. In response, camera accessory 100 can adjust the aperture, zoom, and/or the focus of the attached lens using instructions communicated over electrical connectors 126. These instructions may be received by the camera accessory 100 while it is physically attached to the mobile device 130 (e.g. via connector 110) or while it is physically removed from the mobile device (and may be at a remote location, via wireless connection 601).

Accordingly, embodiments of the mobile device camera accessory may enable a mobile computing device 130, such as a mobile telephone, portable media device, etc., to be used to capture high-quality digital images and movies using a high-quality imaging sensor that is included in a mobile device camera accessory 100. In addition, mobile device camera accessories according to embodiments described herein can enable use of high-quality lenses, such as those used in professional SLR cameras.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware. These computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

A computing system typically includes at least one processing unit and memory. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory of the computing system. Computing system may also contain communication channels that allow the computing system to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory. The system memory may also be referred to as “main memory”, and includes memory locations that are addressable by the at least one processing unit over a memory bus in which case the address location is asserted on the memory bus itself. System memory has been traditional volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

The concepts and features described herein may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed:

1. A mobile device camera accessory, comprising:
a digital imaging sensor;
a camera lens mount that is configured to optically align an interchangeable camera lens with the digital imaging sensor, the camera lens mount housing the digital imaging sensor; and
one or more communications interfaces that provide communication with a mobile computing device, the communications interfaces allowing users of the mobile device camera accessory to control mobile device camera accessory operations using a user interface displayed on the mobile computing device.

2. The mobile device camera accessory of claim 1, further comprising a mobile computing device attachment mechanism that secures the mobile device camera accessory to the mobile computing device.

3. The mobile device camera accessory of claim 2, wherein the mobile computing device attachment mechanism comprises one or more brackets that secure the mobile device camera accessory to the mobile computing device.

4. The mobile device camera accessory of claim 3, wherein the one or more brackets are configured to clip onto the mobile device.

5. The mobile device camera accessory of claim 2, wherein the mobile computing device attachment mechanism comprises a hard-wired connection mechanism.

6. The mobile device camera accessory of claim 5, wherein the hard-wired connection mechanism comprises at least one of a UNIVERSAL SERIAL BUS connector, an APPLE DOCK CONNECTOR, and an APPLE LIGHTNING connector.

7. The mobile device camera accessory of claim 1, wherein the one or more communications interfaces comprises one or more hard-wired communications interfaces.

8. The mobile device camera accessory of claim 7, wherein the one or more hard-wired communications interfaces include at least one of a UNIVERSAL SERIAL BUS connector, an APPLE DOCK CONNECTOR, and an APPLE LIGHTNING connector.

9. The mobile device camera accessory of claim 1, wherein the one or more communications interfaces comprises one or more wireless communications interfaces.

10. The mobile device camera accessory of claim 9, wherein the one or more wireless communications interfaces include at least one of a WIFI interface, a BLUETOOTH interface, and a NEAR FIELD COMMUNICATION (NFC) interface.

11. The mobile device camera accessory of claim 1, wherein the camera lens mount is configured to removably attach to a plurality of different camera lenses.

12. The mobile device camera accessory of claim 1, wherein the camera lens mount includes a communications mechanism for communicating with electronic connectors of an attached lens.

13. The mobile device camera accessory of claim 12, wherein the camera lens mount is configured to attach to lenses that use different types of electrical connectors and correspondingly different communications protocols.

14. The mobile device camera accessory of claim 1, further comprising a camera lens cover that is configured to attach to the mobile computing device and form a grip on the mobile computing device.

15. The mobile device camera accessory of claim 1, wherein the one or more communications interfaces are configured to:
receive one or more instructions from the mobile computing device, the one or more instructions instructing the mobile device accessory to capture a digital image using the digital imaging sensor; and
transfer the captured digital image to the mobile computing device.

16. The mobile device camera accessory of claim 1, further comprising one or more of a headphone connector or a microphone connector.

17. The mobile device camera accessory of claim 1, further comprising a camera lens.

18. The mobile device camera accessory of claim 17, wherein the camera lens includes at least one of a focus adjustment mechanism and a zoom adjustment mechanism.

19. A mobile device camera accessory system, comprising:
an accessory base, comprising:
a digital imaging sensor;
a camera lens mount;
a mobile computing device mount; and
one or more communications interfaces that are configured to communicate with a mobile computing device; and
a camera lens that is configured to attach to the camera lens mount and to optically align over the digital imaging sensor when attached to the camera lens mount.

20. The mobile device camera accessory system of claim 19, wherein the accessory base further comprises at least one of a headphone connector, a microphone connector, and a mobile device connector.

21. The mobile device camera accessory system of claim 19, wherein the camera lens comprises one or both of a zoom control mechanism and a focus control mechanism.

22. The mobile device camera accessory system of claim 22, wherein the accessory base further comprises a shutter button.

23. The mobile device camera accessory system of claim 22, wherein the lens mount and the camera lens are configured to form an electrical contact with one another.

24. The mobile device camera accessory system of claim 22, further comprising a lens cap that is configured to removably attach to both the camera lens and the mobile computing device, wherein the lens cap is configured to form a grip when attached to the mobile computing device.

25. A method for capturing a digital image, comprising:
a camera accessory establishing one or more communications channels with a mobile computing device;
the camera accessory communicating one or more of an identity or a current state of an attached lens to the mobile computing device;
the camera accessory receiving one or more instructions from the mobile computing device over the one or more communications channels, the one or more instructions instructing the camera accessory to capture a digital image at a digital imaging sensor at the camera accessory; and
the camera accessory transferring the captured digital image to the mobile computing device over the one or more communications channels.

26. The method of claim 25, further comprising:
the camera accessory receiving one or more second instructions from the mobile computing device over the one or more communications channels, the one or more second instructions instructing the camera accessory to adjust one or more of an aperture, a zoom, or a focus of the attached lens; and
the camera accessory adjusting one or more of the aperture, the zoom, or the focus of the attached lens based on the one or more second instructions.
